(19) United States
(12) Patent Application Publication
(10) Pub. No.: US 2002/0010590 A1
(43) Pub. Date: Jan. 24, 2002

(54) Language independent voice communication system

(76) Inventor: Soo Sung Lee, Seoul (KR)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(21) Appl. No.: 09/901,791

(22) Filed: Jul. 10, 2001

(30) Foreign Application Priority Data
Jul. 11, 2000 (KR) 2000-39663

(51) Int. Cl. G10L 21/00

(52) U.S. Cl. 704/277

(57) ABSTRACT

A language independent voice communication system includes a translation unit for translating a one language input speech to one or more corresponding other language speeches. The translation unit comprises includes a speech recognizer for recognizing the input speech, at least one translation module electrically connected to the speech recognizer for translating the recognized first language input speech to the corresponding other language speech; and output means electrically connected to the translation modules for outputting the translated speeches.

### BACKGROUND OF THE INVENTION

(a) Field of the Invention

The present invention relates to a language independent voice communication system and, in particular, to a language independent voice communication system enabling people using different languages to communicate each other in real time using an improved speech recognition and multi-language translation mechanism through wire or wireless communication networks.

(b) Description of the Related Art

Generally, many countries have developed speech recognition technologies, that recognizes their own native or official language as sentence base. The speech recognition technology has been adopted for operating electronic appliances such as computer, cellular phone, automatic door, etc. in accordance with voice commands.

Also, the speech recognition technology is used for language educational purpose in such a way that a computer terminal displays an input speech inputted through a microphone as phrases as pronounced and spelled.

In this speech recognition technology, the input speech is searched in a large quantity of frequently spoken samples that are previously recorded in a storage medium and sequentially displayed as corresponding phrases if there exists the corresponding phrases. On the other hand, if there exists no corresponding phrase, an error message is displayed.

However, since this technology is limitedly applied to only a few languages such as universal or native one, an implementation of an inter-language translation service using the speech recognition technology is difficult particularly in wire and wireless communication fields such as international calling service and computer network communication.

### SUMMARY OF THE INVENTION

The present invention has been made in an effort to solve the above problems.

It is an object of the present invention to a language independent voice communication system enabling people using different languages to communicate each other in real time using an improved speech recognition and multi-language translation mechanism through wire or wireless communication networks.

To achieve the above abject, the language independent voice communication system of the present invention comprises, a translation unit for translating a one language input speech to one or more corresponding other language speeches. The translation unit comprises a speech recognizer for recognizing the input speech, at least one translation module electrically connected to the speech recognizer for translating the recognized first language input speech to the corresponding other language speech, and output means electrically connected to the translation modules for outputting the translated speeches.

### BRIEF DESCRIPTION OF THE DRAWINGS

The above and other objects and features of the instant invention will become apparent from the following description of preferred embodiments taken in conjunction with the accompanying drawings, in which:

FIG. 1 is a schematic view illustrating a language independent voice communication system in accordance with a preferred embodiment of the present invention;

FIG. 2 is a circuit diagram illustrating translation unit of the language independent voice communication system of FIG. 1;

FIG. 3 is a circuit diagram illustrating translation unit of the language independent voice communication system in accordance with another preferred embodiment of the present invention; and

FIG. 4 is a circuit diagram illustrating translation unit of the language independent voice communication system in accordance with still another preferred embodiment of the present invention.

### DETAILED DESCRIPTION OF THE PREFERRED EMBODIMENTS

Preferred embodiments of the present invention will be described hereinafter with reference to the accompanying drawings.

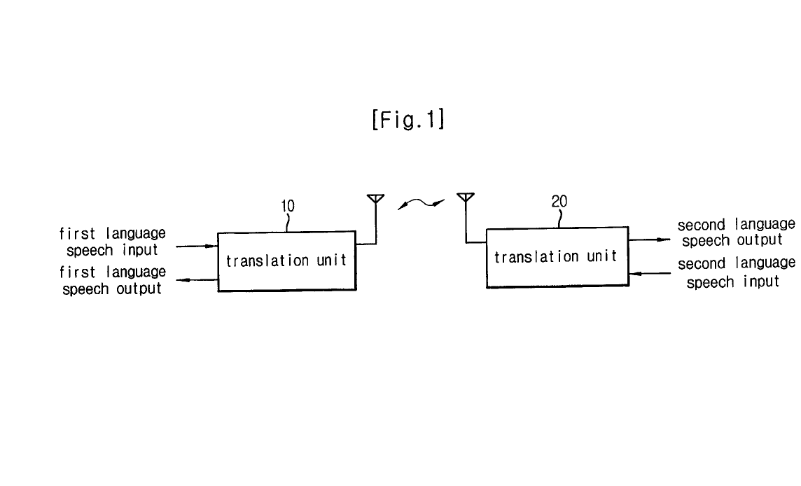

The language independent voice communication system of the present invention can recognize and translate one language into one or more languages and vice versa. However, to simplify the explanation, two different languages, i.e., English and Korean, are exemplary adopted for implementing the recognition and translation mechanism of the language independent voice communication system of the present invention. Referring to FIG. 1, the language independent voice communication system of the present invention comprises first and second language translation unit.

The first language translation unit recognizes a first language (Korean) input speech, phrases the recognized first language input speech, translates the first language phrase into a corresponding second language (English) phrase, and transmits the translated second language phrase in encoded signal.

The second language translation unit receives the encoded second language (English) phrase signal from the first language translation unit, decodes the second language signal into the second language phrase, and outputs the second language phrase in a corresponding second language speech.

Also, it is possible that the first translation unit 10 encodes the first language speech (Korean) into a first language speech signal and transmits the encoded first language speech signal such that the second translation unit 10 decodes the first language speech signal received from the first language translation unit, phrases the first language speech into a first language phrase, translates the first language phrase into the corresponding second language (English) phrase, and outputs the second language phrase in second language speech.

The first and second language translation unit have functions so as to recognize a plurality of language-based speeches, transmit and receive signals, translate one language phrase into corresponding other language phrase, vice versa, verbalize a plurality of language-based phrases.

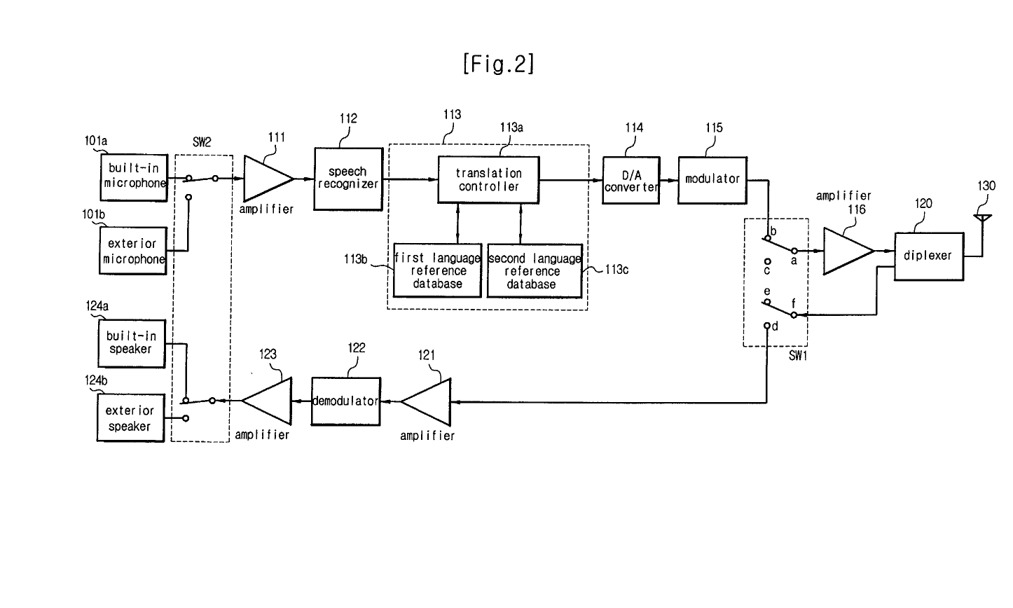

FIG. 2 is a circuit diagram showing the translation unit of the language independent voice communication system according to a first preferred embodiment of the present invention.

Referring to FIG. 2, the translation unit comprises at least one microphone 101a (101b) for inputting a speech, at least one speaker 124a (124b) for outputting the speech, a second switch unit SW2 for selecting the appropriate microphone 101a (101b) and speaker 124a (124b), an input and output amplifiers 111 and 123 connected to the first switch unit SW2 for amplifying respective input and output signals, a speech recognizer 112 connected to the input amplifier 111, the speech recognizer 112 for recognizing the input speech signal, the speech recognizer 112 having an analog/digital (A/D) converter, a translation module 113 connected to the speech recognizer 112 for interpreting a first language speech signal into a corresponding second language speech signal, a digital/analog (D/A) converter 114 connected to the translation module 113 for converting the digital second language speech signal into an analog second language signal, a modulator 115, a first switch unit SW1 for selecting one of an transmitting and receiving modes, a transmission amplifier 116 for amplifying transmission signal, a receiving amplifier 121 connected to the first switch unit SW1 for amplifying a receiving signal, a demodulator 122 interposed between the output amplifier 123 and the receiving amplifier 121 for demodulating the received signal, and a diplexer 120 for transmitting signal through an antenna 130.

The switch unit SW2 is a headset jack such that the speech input and output are performed through an exterior microphone 101b and earphone 124b of the headset when the jack is connected into a receiving port (not shown) and through a built-in microphone 101a and speaker 124a when the jack is disconnected.

The translation module 113 comprises a first language reference database first language 113b for storing first language speech samples, a second language reference database 113c for storing second-language speech samples, and a translation controller 113a (e.g. preferred using microprocessor) for controlling translation of the first language speech into the second language speech.

The translation controller 113a, sequentially, refers to the first language reference database 113b when receiving a first language speech signal from the speech recognizer 112, phrases the first language speech if a same or similar speech sample exists in the first language reference database 113b, refers to the second language reference database 113c for finding a corresponding second language phrase, translates the first language phrase into a corresponding second language phrase if the corresponding second language phrase exists in the second reference database 113c, and produces a corresponding second language speech signal.

The first and second language reference databases 113b and 113c have the same structure and each reference database 113b (113c) has a mapping table (not shown) for mapping speech signal to corresponding phrase such that a speech signal is mapped to a phrase, vice versa. The translation controller 113a calculates a percentage of an identical proportion of between the input speech signal and the referred speech sample in the first and second language reference databases 113b and 113c so as to map the input speech signal to the corresponding reference speech sample if the identical percentage is equal to or greater than a predetermined threshold value. The input speech signal having the identical percentage equal to or greater than the predetermined threshold value is learned and stored in a previously assigned area of the reference database 113b (113c) together with the percentage value so as to accelerate translation by referring to speech sample in descending order of the percentage when the same input speech pattern is inputted next time.

Also, the translation controller 113a detects finally referred times of the speech samples in case when there is a plurality of corresponding speech sample in the reference database 113b (113c) so as to map the input speech signal to the lately referred speech sample among them.

The speech samples are grouped into at least one group in accordance with referred frequency such that the translation controller 113a refers to the reference database 113b (113c) from a frequently referred group, resulting in reducing a speech sample reference time.

The translation module 113 is a removable/attachable module implemented in a read only memory pack (ROM PACK) such that one or more translation modules, each having different language reference databases, can be attached to the translation unit 10 (20) or be changed each other.

In case when a plurality of translation modules 113 are attached to the translation unit 10 (20), the translation modules 113 are connected to the speech recognizer 112 in parallel and distinguishes input speech languages using language codes (for example, Korean=001, English=002, Chinese=003, Japanese=004, etc.) assigned to the different languages so as to enable one language speech to be translated into a plurality of different language speeches by detecting sequential language codes. That is, if the sequential code is “001002”, the input speech signal is Korean and output speech signal is English, and if the sequential code is “001003”, the input speech signal is Korean and the output speech signal is Chinese.

The operation of the language independent voice communication system according to the first preferred embodiment of the present invention will be described hereinafter.

Once the second switch unit SW2 of the first translation unit 10 (see FIG. 1) is on for transmitting mode, a first language (Korean) input speech signal from the microphone 101a (101b) is amplified by the amplifier 111 and then the first language input speech signal digitalized by the speech recognizer 112. Consequently, the digitalized first language input speech signal is sent to the translation module 113 such that the translation controller 113a temporally stores the first language input speech signal and looks up the first language reference database 113b for finding the same or similar speech sample therein. If the speech sample exists in the first language reference database 113b, the translation controller 113 looks up the second language (English) reference database 113c for finding a corresponding second language speech sample. If the corresponding second language speech sample exists in the second language reference database 113c, the translation controller 113a sends the corresponding second language speech sample to the D/A converter 114. The second language speech sample is converted into an analog second language speech signal and then modulated for wireless propagation in the modulator 115. The modulated second language speech signal is transmitted to the second translation unit 20 (see FIG. 1) through the first switch unit SW1, the amplifier 116, the diplexer, and the antenna 130. The second language speech signal received through the antenna 130 of the second translation unit 20 is sent to the demodulator 122 via the diplexer 120, the first switch unit SW1, and the amplifier 121 such that the second language speech signal is demodulated and outputted through the speak 124a (124b) as the second language speech. In the receiving mode, terminals f and d of the first switch unit SW1 are connected.

Also, when the second language speech is inputted through the microphone 101a (101b) a translation unit, the corresponding first language speech is outputted through the speaker 124a (124b) of the counterpart translation unit through the above-explained processes.

The translation controller 113a, sequentially, refers to the first language reference database 113b when receiving a first language speech signal from the speech recognizer 112, phrases the first language speech if a same or similar speech sample exists in the first language reference database 113b, refers to the second language reference database 113c for finding a corresponding second language phrase, translates the first language phrase into a corresponding second language phrase if the corresponding second language phrase exists in the second reference database 113c, and produces a corresponding second language speech signal.

The first and second language reference databases 113b and 113c have the same structure and each reference database 113b (113c) has a mapping table (not shown) for mapping speech signal to corresponding phrase such that a speech signal is mapped to a phrase, vice versa.

The translation controller 113a calculates a percentage of an identical proportion between the input speech signal and the referred speech sample in the first and second language reference databases 113b and 113c so as to map the input speech signal to the corresponding reference speech sample if the identical percentage is equal to or greater than a predetermined threshold value of 80%. The input speech signal having the identical percentage equal to or greater than 80% is learned and stored in a previously assigned area of the reference database 113b (113c) together with the percentage value so as to accelerate translation by referring to speech sample in descending order of the percentage when the same input speech pattern is inputted next time.

Also, the translation controller 113a detects finally referred times of the speech samples in case when there exists a plurality of corresponding speech sample having 100% of identical percentage in the reference database 113b (113c) so as to map the input speech signal to the lately referred speech sample among them.

The speech samples are grouped into at least one group in accordance with referred frequency such that the translation controller 113a refers to the reference database 113b (113c) from a frequently referred group having the highest reference priority, resulting in reducing a speech sample reference time.

The translation module 113 is a removable/attachable module implemented in a read only memory pack (ROM PACK) such that one or more translation modules, each having different language reference databases, can be attached to the translation unit 10 (20) or be changed each other. Also, the language databases can be modularized as the ROM PACK such that a plurality of languages can be translated.

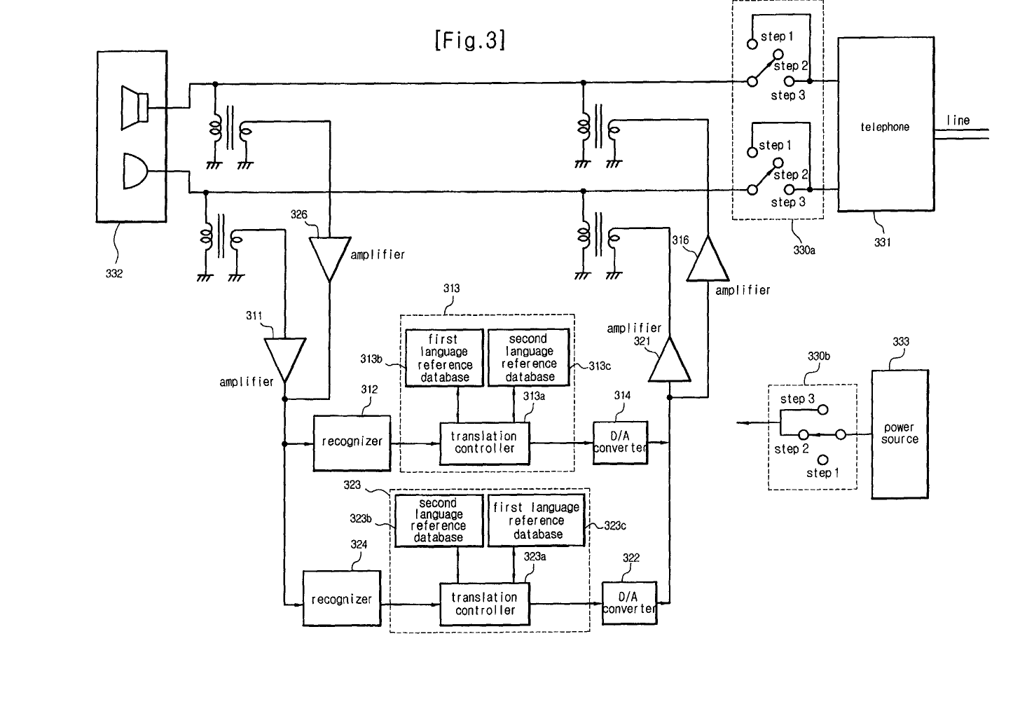

A second preferred embodiment of the present invention will be described hereinafter with reference to the accompanying FIG. 3.

In the second preferred embodiment of the present invention, the language independent voice communication system is implemented in a telephone network.

FIG. 3 is a circuit diagram illustrating the translation unit implemented in a telephone set.

The translation unit 10 (20) is interposed between a main body 331 and a handset (or headset) 332 of the telephone set so as to translate a first language input speech signal from the handset 332 into a second language output speech signal and output the translated second language speech signal to the main body 331. Also, the translation unit 10 (20) translates a second language input speech signal from the main body 331 via a telephone network into a second language speech signal and send output the translated first language speech signal to the handset 332.

The translation unit 10 (20) comprises a first and second speech recognizers 312 and 324 having respective A/D converters, a first language translation module 313 connected to the first speech recognizer 312 for translating the first language speech signal into the second language speech signal, and a second language translation module 323 connected to the second language speech recognizer 324 for translating the second language speech signal into the first language speech signal.

The translation module 313 (323) comprises a first language reference database 313b (323b) for storing first language speech samples, a second language reference database 313c for storing second language speech samples, and a translation controller 313a (323a) for controlling translation of the first language speech into the second language speech.

The translation controller 313a (323a), sequentially, refers to the first language reference database 313b (323b) when receiving a first language speech signal from the speech recognizer 312 (324, phrases the first language speech if a same or similar speech sample exists in the first language reference database 313b (323b), refers to the second language reference database 313c (323c) for finding a corresponding second language phrase, translates the first language phrase into a corresponding second language phrase if the corresponding second language phrase exists in the second reference database 113c, and produces a corresponding second language speech signal.

In this embodiment, since the two translation modules 313 and 323 are attached in parallel, it is possible to provide a translation and language education functions by connecting the handset of the telephone set to the input part of the translation unit and connecting the output part of the translation unit to a handset connection port. Also, the translation unit can be selectively set as a bypass mode just for bypassing, translation mode, and tele-translation mode using a 3-way switch 330b.

Also, the translation unit can provide translation function between the mobile phones or between the mobile and wired phones by connecting a headset of the mobile phone to the input part of the translation unit and connecting the output part of the translation unit to the headset port of the mobile phone. In this case, the mobile phone can be used as a portable language-training device.

Furthermore, the translation unit can be provided as an internet phone service connection by connecting a microphone and speaker jack of a personal computer (PC) having internet phone function to the output part of the translation unit and connecting the input part of the translation unit to a microphone and speaker ports of the PC.

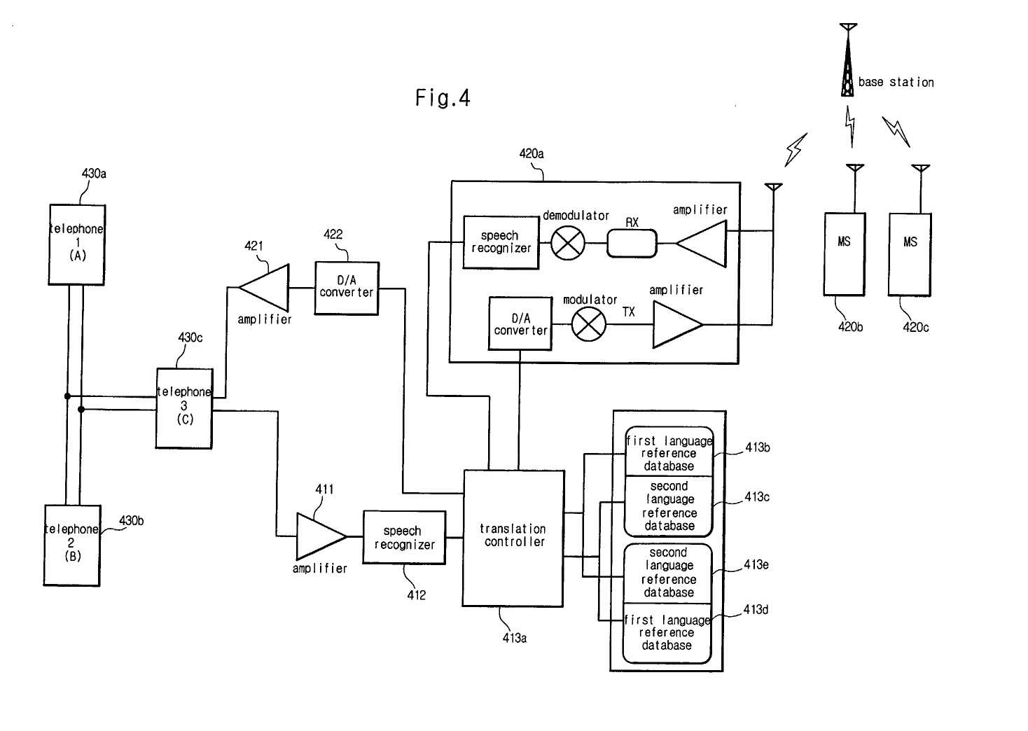

A third preferred embodiment of the present invention will be described hereinafter with reference to the accompanying FIG. 4.

FIG. 4 is a circuit diagram illustrating the language independent voice communication system implemented in a mobile communication network. Referring to FIG. 4, the language independent voice communication system comprises wire/wireless translation unit. The wire/wireless translation unit connected to a telephone set 430c via physical lines and wirelessly communicates with a base station such that the wire/wireless translation unit translates a first (second) language input speech signal from the telephone set 430c into a second (first) language output speech signal so as to transmit the translated output speech signal through a physical or/and wireless channels, vice versa.

The wire/wireless translation unit comprises at least one translation module that translates at least one language speech signal into at least one corresponding other language speech signal.

The wire/wireless translation unit comprises wire communication supporting unit interposed between a telephone set 430c and the translation module 314a and wireless communication supporting unit 420b interposed between the translation module 413a and an antenna.

The wire communication supporting means is provided with a first amplifier 411, a speech recognizer 412 including an A/D converter, a second amplifier 421, and a D/A converter 422 so as to support speech signal communication between the telephone set 430c and the translation module 314a.

The wireless communication supporting means 420a is provided with a pair of A/D and D/A converters, a pair of modulator and demodulators, a pair of input and output amplifiers so as to support wireless speech signal communication between the translation module 413a and other mobile stations 420b and 420c. The mobile station can be a cellular phone or Trunked Radio System (TRS) phone.

The telephone set 430c can be bridged with other telephone sets 430a and 430c so as to receive the speech signal from the translation module 413a.

Also, the wireless communication supporting means 420a can be bridged with other mobile stations 420c and 420c having the same manufactured serial number in cellular communication or having same channel in TRS communication so as to receive the same speech signal from the translation module 413a via the base station.

The translation module 413a has at least two language reference databases, each being provided with mapping tables for mapping one language speech signal 413b (413c) to other language speech signal 413e (413d).

In this embodiment of the present invention, the translation function can be provided between two mobile stations that have the same manufactured serial number (it is possible only when the mobile communication company provides same identification code to the two mobile station).

That is, one of the two mobile stations 420a and 420b becomes a transmitter and the other a receiver such that a first language speech from the transmitter is outputted as a corresponding second language speech at the no receiver. In order to expect this mobile communication translation, the translation unit provides an integrated first (Korean) and second (English) language input modules connected in parallel and an integrated first and second language output modules connected in parallel.

To translate one language speech into another, a specific code is assigned to each language, for example, Korean=001, English=002, Chinese=003, Japanese=004, French=005, etc. such that a translation language pair can be selected by sequentially entering two language codes. Exemplary, an English-to-Korean translation is required, the translation unit is set by entering sequential code of “002001.”

Also, the translation unit implemented in a cellular phone can provide translation function by connecting a jack integrated, in parallel, with two pair of headsets to a jack port of the cellular phone. In this case, the microphones and earphones of the two pair headsets should be balanced in impedance by increasing the impedances of the microphones and earphones twice.

The translation unit can be applied to a computer network in order to provide an online translation service in such a manner that if a server equipped with the translation unit together with a plurality of different language reference samples receives a speech signal from a client computer translates the received speech signal into a required language speech signal and returns the translated speech signal to the client such that the client computer output the translated speech through a speaker installed therein. In this manner, the translation unit can be used for the purpose of commercial translation or online dictionary service.

As described above, the language independent voice communication system of the present invention uses the speech recognition technologies developed in various countries for their domestic purposes by modularizing each speech recognition technology such that there is no need to develop other speech recognizer engine, resulting in reduction of development time consumption.

Also, since the language independent voice communication system of the present invention uses a plurality of different language translation modules connected in parallel, one language can be translated into several other languages at the same time independent to the input language.

Furthermore, by utilizing the translation unit of the present invention in the wire and/or wireless communication networks, the language independent voice communication system can be applied to various fields such as the language independent conference, online translation and dictionary services, etc.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A language independent voice communication system comprises:
a translation unit for translating a one language input speech to one or more corresponding other language speeches.

2. The language independent voice communication system of claim 1 wherein the translation unit comprises:
a speech recognizer for recognizing the input speech;
at least one translation module electrically connected to the speech recognizer for translating the recognized first language input speech to the corresponding other language speech; and
output means electrically connected to the translation modules for outputting the translated speeches.

3. The language independent voice communication system of claim 2 wherein the speech recognizer is provided with an A/D converter for converting an analog input speech signal into a digital input speech signal.

4. The language independent voice communication system of claim 2 wherein the translation module comprises:
a first language reference database for storing first language speech samples;
a second language reference database for storing second language speech samples; and
a translation controller for controlling translation of the first language digital input speech signal into a second language digital output speech signal by referring to the first and second language reference databases.

5. The language independent voice communication system of claim 4 wherein the output means comprises a speaker for outputting the second language speech.

6. The language independent voice communication system of claim 4 wherein the output means comprises:
a D/A converter for converting the second language digital output speech signal into a second language analog output speech signal;
a modulator for modulating the analog output speech signal; and
an antenna for transmitting the modulated output speech signal.

7. The language independent voice communication system of claim 4 wherein the translation controller translates the first language speech samples stored in the first language reference database to corresponding second language speech samples stored in the second language reference database.

8. The language independent voice communication system of claim 4 wherein the first language reference database has a first language mapping table for mapping the first language speech samples to corresponding first language phrases.

9. The language independent voice communication system of claim 8 wherein the second language reference database has a second language mapping table for mapping the second language speech samples to corresponding second language phrases.

10. The language independent voice communication system of claim 9 wherein the translation controller translates the first language phrases to corresponding second language phrases by referring to the first and second language mapping tables.

11. The language independent voice communication system of claim 10 wherein the second language phrase is outputted as a second language digital speech signal under control of the translation controller.

12. The language independent voice communication system of claim 11 wherein the second language digital speech signal is converted into a second language analog signal by the D/A converter.

13. The language independent voice communication system of claim 7 wherein the translation controller looks up the first language reference database for finding target first language speech sample corresponding to the first language speech signal.

14. The language independent voice communication system of claim 13 wherein the translation controller calculates a percentage of an identical proportion between the first language speech signal and the first language speech samples.

15. The language independent voice communication system of claim 14 wherein the translation controller extracts candidate samples on the basis of the identical proportion.

16. The language independent voice communication system of claim 15 wherein the translation controller determines the first language reference samples having identical percentage value equal to or greater than a predetermined threshold value as the candidate samples.

17. The language independent voice communication system of claim 16 wherein the translation controller determines one of the candidate samples having a highest identical percentage value as a target first language speech sample.

18. The language independent voice communication system of claim 17 the translation controller detects lately referred times of the reference samples when a plurality of candidate samples having 100% of identical percentage.

19. The language independent voice communication system of claim 17 wherein the translation controller learns and stores the target first language speech sample in a predetermined area of the first language reference database together with the proportional value so as to accelerate translation by referring to speech samples in descending order of the percentage when a input speech signal having a same pattern is inputted next time.

20. The language independent voice communication system of claim 19 wherein the speech samples are grouped in at least one group according to referred frequency such that the translation controller refers to the reference database from a frequently referred group having a highest reference priority.

21. The language independent voice communication system of claim 4 wherein translation module is a removable/attachable read only memory pack (ROM PACK) so as to be changed according to a pair of translation-required languages.

22. The language independent voice communication system of claim 4 wherein a plurality of translation modules having a pair of different language reference databases are attached to the translation unit in parallel so as to translate one language input speech to at least one other language output speech.

23. The language independent voice communication system of claim 22 wherein the translation modules have respective language code tables and detect the translation language pair by looking up the table when a sequential language codes are inputted.

24. The language independent voice communication system of claim 1 further comprises at least one counterpart translation unit.

25. The language independent voice communication system of claim 24 wherein each translation unit is interposed between a main body and a handset of a telephone set.

26. The language independent voice communication system of claim 25 wherein handset is connected to an input port of the translation unit and the main body of the telephone is connected to an output port of the translation unit.

27. The language independent voice communication system of claim 26 wherein the translation unit comprises:
a speech recognizer for recognizing the input speech;
at least one translation module electrically connected to the speech recognizer for translating the recognized first language input speech to the corresponding other language speech; and
output means electrically connected to the translation modules for outputting the translated speeches.

28. The language independent voice communication system of claim 27 wherein the speech recognizer is provided with an A/D converter for converting an analog input speech signal into a digital speech signal.

29. The language independent voice communication system of claim 27 wherein the translation module comprises:
a first language reference database for storing first language speech samples;
a second language reference database for storing second language speech samples; and
a translation controller for controlling translation of the first language speech signal into a second language speech.

30. The language independent voice communication system of claim 27 wherein the output means connected to a handset connection port of the main body of the telephone set such that the second language speech signal is transmitted to the counterpart translation unit via a public switched telephone network (PSTN).

31. The language independent voice communication system of claim 29 wherein the translation controller translates the first language speech samples stored in the first language reference database to corresponding second language speech samples stored in the second language reference database.

32. The language independent voice communication system of claim 29 wherein the first language reference database has a first language mapping table for mapping the first language speech samples to corresponding first language phrases.

33. The language independent voice communication system of claim 29 wherein the second language reference database has a second language mapping table for mapping the second language speech samples to corresponding second language phrases.

34. The language independent voice communication system of claim 33 wherein the translation controller translates the first language phrases to corresponding second language phrases by referring to the first and second language mapping tables.

35. The language independent voice communication system of claim 34 wherein the second language phrase is outputted as a second language digital speech signal under control of the translation controller.

36. The language independent voice communication system of claim 35 wherein the second language digital speech signal is converted into a second language analog signal by the D/A converter.

37. The language independent voice communication system of claim 29 wherein the translation controller looks up the first language reference database for finding target first language speech sample corresponding to the first language speech signal.

38. The language independent voice communication system of claim 37 wherein the translation controller calculates a percentage of an identical proportion between the first language speech signal and the first language speech samples.

39. The language independent voice communication system of claim 38 wherein the translation controller extracts candidate samples on the basis of the identical percentage.

40. The language independent voice communication system of claim 39 wherein the translation controller determines the first language reference samples having identical percentage value equal to or greater than a predetermined threshold value as the candidate samples.

41. The language independent voice communication system of claim 40 wherein the translation controller determines one of the candidate samples having a highest identical percentage value as a target first language speech sample.

42. The language independent voice communication system of claim 41 the translation controller detects lately referred times of the reference samples when a plurality of candidate samples having 100% of identical percentage.

43. The language independent voice communication system of claim 41 wherein the translation controller learns and stores the target first language speech sample in a predetermined area of the first language reference database together with the proportional value so as to accelerate translation by referring to speech samples in descending order of the percentage when a input speech signal having a same pattern is inputted next time.

44. The language independent voice communication system of claim 43 wherein the speech samples are grouped in at least one group according to referred frequency such that the translation controller refers to the reference database from a frequently referred group having a highest reference priority.

45. The language independent voice communication system of claim 27 wherein the translation module is a removable/attachable read only memory pack (ROM PACK) so as to be changed according to a pair of translation-required languages.

46. The language independent voice communication system of claim 27 wherein a plurality of translation modules having a pair of different language reference databases are attached to the translation unit in parallel so as to translate one language input speech to at least one other language output speech.

47. The language independent voice communication system of claim 46 wherein the translation modules have respective language code tables and detect the translation language pair by looking up the table when a sequential language codes are inputted.

48. The language independent voice communication system of claim 24 wherein translation unit is connected to a telephone set and/or cellular phone.

49. The language independent voice communication system of claim 48 wherein the translation unit comprises:
a speech recognizer for recognizing the input speech;
at least one translation module electrically connected to the speech recognizer for translating the recognized first language input speech to the corresponding other language speech; and
output means electrically connected to the translation modules for outputting the translated speeches.

50. The language independent voice communication system of claim 49 wherein the speech recognizer is provided with an A/D converter for converting an analog input speech signal into a digital speech signal.

51. The language independent voice communication system of claim 49 wherein the translation module comprises:
a first language reference database for storing first language speech samples;
a second language reference database for storing second language speech samples; and
a translation controller for controlling translation of the first language speech signal into a second language speech.

52. The language independent voice communication system of claim 49 wherein the output means of the translation unit is connected to a headset port of a cellular phone or/and a handset port of main body of a telephone set and an input port of the translation unit is connected to a headset of the cellular phone or/and a handset of the telephone set.

53. The language independent voice communication system of claim 51 wherein the translation controller translates the first language speech samples stored in the first language reference database to corresponding second language speech samples stored in the second language reference database.

54. The language independent voice communication system of claim 51 wherein the first language reference database has a first language mapping table for mapping the first language speech samples to corresponding first language phrases.

55. The language independent voice communication system of claim 51 wherein the second language reference database has a second language mapping table for mapping the second language speech samples to corresponding second language phrases.

56. The language independent voice communication system of claim 55 wherein the translation controller translates the first language phrases to corresponding second language phrases by referring to the first and second language mapping tables.

57. The language independent voice communication system of claim 56 wherein the second language phrase is outputted as a second language digital speech signal under control of the translation controller.

58. The language independent voice communication system of claim 57 wherein the second language digital speech signal is converted into a second language analog signal by the D/A converter.

59. The language independent voice communication system of claim 51 wherein the translation controller looks up the first language reference database for finding target first language speech sample corresponding to the first language speech signal.

60. The language independent voice communication system of claim 59 wherein the translation controller calculates a percentage of an identical proportion between the first language speech signal and the first language speech samples.

61. The language independent voice communication system of claim 60 wherein the translation controller extracts candidate samples on the basis of the identical percentage.

62. The language independent voice communication system of claim 61 wherein the translation controller determines the first language reference samples having identical percentage value equal to or greater than a predetermined threshold value as the candidate samples.

63. The language independent voice communication system of claim 62 wherein the translation controller determines one of the candidate samples having a highest identical percentage value as a target first language speech sample.

64. The language independent voice communication system of claim 63 the translation controller detects lately referred times of the reference samples when a plurality of candidate samples having 100% of identical percentage.

65. The language independent voice communication system of claim 63 wherein the translation controller learns and stores the target first language speech sample in a predetermined area of the first language reference database together with the proportional value so as to accelerate translation by referring to speech samples in descending order of the percentage when a input speech signal having a same pattern is inputted next time.

66. The language independent voice communication system of claim 65 wherein the speech samples are grouped in at least one group according to referred frequency such that the translation controller refers to the reference database from a frequently referred group having a highest reference priority.

67. The language independent voice communication system of claim 49 wherein the translation module is a removable/attachable read only memory pack (ROM PACK) so as to be changed according to a pair of translation-required languages.

68. The language independent voice communication system of claim 49 wherein a plurality of translation modules having a pair of different language reference databases are attached to the translation unit in parallel so as to translate one language input speech to at least one other language output speech.

69. The language independent voice communication system of claim 68 wherein the translation modules have respective language code tables and detect the translation language pair by looking up the table when a sequential language codes are inputted.
